(19) United States
(12) Patent Application Publication
(10) Pub. No.: US 2025/0371805 A1
(43) Pub. Date: Dec. 4, 2025

(54) FRAMEWORK FOR ANALYSIS OF DYNAMIC POINT CLOUDS

(71) Applicant: The Board of Regents of University of Nebraska, Lincoln, NE (US)

(72) Inventors: Christine Wittich, Lincoln, NE (US); Khalid Alkady, Lincoln, NE (US); Richard Wood, Lincoln, NE (US)

(21) Appl. No.: 19/225,696

(22) Filed: Jun. 2, 2025

Related U.S. Application Data
(60) Provisional application No. 63/654,598, filed on May 31, 2024.

(51) Int. Cl. G06T 17/20; G01S 17/89

(52) U.S. Cl. CPC G06T 17/20; G01S 17/89

(57) ABSTRACT

Techniques for monitoring the dynamic response of a structure using lidar scanning are disclosed. The method includes acquiring point cloud data of the structure over time using a lidar system, processing the point cloud data to isolate the structure from background elements, and partitioning the isolated point cloud data into spatial regions. Changes in the spatial regions are detected over time to determine dynamic displacements of the structure, and a displacement time history is generated based on the detected displacements. The system includes a lidar scanner and a computing device configured to control the scanner, process the acquired point cloud data, and output the displacement time history. The techniques enables remote, continuous, and autonomous monitoring of structural vibrations and dynamic behavior, facilitating applications such as structural health monitoring, damage detection, and operational analysis.

### CROSS-REFERENCE TO RELATED APPLICATION(S)

This application claims the benefit under 35 U.S.C. § 119 (e) to U.S. Provisional Application 63/654,598, filed May 31, 2024, and entitled “FRAMEWORK FOR ANALYSIS OF DYANMIC POINT CLOUDS”, which is hereby incorporated herein by reference in its entirety.

### GOVERNMENT SUPPORT

This invention was made with government support under Grant No. 69A3551747107, awarded by the United States Department of Transportation. The government has certain rights in the invention.

### FIELD

The various examples herein relate to structural health monitoring technologies for the ongoing observation of vibrations and deformations in civil infrastructure.

### BACKGROUND

The field of monitoring the dynamic behavior of civil structures has traditionally depended on contact-based sensors and discrete instrumentation to capture vibration and deformation data. Conventional techniques have served to assess structural performance under various loads, yet these methods face limitations due to their reliance on point measurements. In many cases, such approaches do not provide the full-field coverage required to detect subtle changes over a structure's entire extent. The integration of remote sensing methods, such as laser scanning, has introduced an opportunity to achieve higher spatial resolution and more comprehensive dynamic assessments, although these approaches bring their own challenges regarding data processing and reliability.

Despite significant advancements in remote sensing technologies, many existing methods encounter difficulties when handling the extensive quantities of data generated by high-resolution scanning. Dense, three-dimensional datasets demand substantial computational capabilities for processing and analysis, often resulting in trade-offs between data resolution and sampling frequency. These trade-offs can influence the precision and dependability of dynamic measurements, particularly when detecting rapid or subtle changes. Furthermore, processing large datasets efficiently continues to pose challenges, potentially delaying the provision of real-time or near-real-time assessments of structural health.

A notable challenge lies in reliably extracting dynamic vibration information from complex, noisy datasets. Traditional contact sensor methods are constrained by the need for physical installation and limited spatial coverage, while remote sensing techniques can be sensitive to environmental interference and data noise, thereby reducing measurement fidelity. Moreover, the development of methods capable of autonomously processing time-stamped, three-dimensional data into meaningful dynamic displacement histories requires overcoming substantial computational and algorithmic hurdles.

### BRIEF SUMMARY

Discussed herein are various techniques that provide a framework for remotely monitoring the dynamic response of structures using lidar scanning and advanced point cloud processing techniques. By leveraging a ground-based lidar system operating in a helical scanning mode, the invention enables the acquisition of high-resolution, time-stamped point cloud data representing the structure's dynamic behavior. The acquired data is processed to isolate the structure from background elements, partition the point cloud into spatial regions, and detect changes in these regions over time. This process generates a displacement time history that captures the dynamic vibrations and deformations of the structure.

The techniques introduce a two-step spatio-temporal algorithm that combines density-based spatial clustering and voxelization to efficiently process the point cloud data. This algorithm facilitates the extraction of meaningful dynamic information from dense and noisy datasets, enabling accurate monitoring of sub-millimeter displacements. The displacement time history can be used to assess structural health, estimate dynamic parameters such as natural frequencies and mode shapes, and generate alerts or recommendations for maintenance, operational adjustments, or risk mitigation.

The disclosed system and method are scalable, autonomous, and capable of continuous monitoring, eliminating the need for physical sensor installation on the structure. This approach reduces costs, enhances safety, and provides full-field coverage for a wide range of civil infrastructure applications, including bridges, buildings, dams, and other critical structures. By addressing the limitations of traditional contact-based monitoring systems, the invention offers a robust solution for structural health monitoring, damage detection, and operational analysis.

In Example 1, a method comprises controlling, by one or more processors, a scanner device to conduct a scan of a plurality of points on a structure; receiving, by the one or more processors and as a result of the scan, a series of scanlines of a field of view of the scanner device, each scanline including a timestamp of an instance of scanning each point of the plurality of points on the structure; generating, by the one or more processors, a dynamic point cloud from the series of scanlines; processing, by the one or more processors, a reference point cloud in the dynamic point cloud to cluster the dynamic point cloud based on densities to generate a clustered reference point cloud, wherein the reference point cloud comprises a portion of the dynamic point cloud generated from a first scanline of the series of scanlines; voxelizing, by the one or more processors, the clustered reference point cloud to generate a voxelized reference point cloud; using, by the one or more processors, the voxelized reference point cloud to cluster and voxelize a remainder of the dynamic point cloud to generate a voxelized dynamic point cloud; extracting, by the one or more processors, a dynamic response of each voxel in the voxelized dynamic point cloud by comparing a point in the respective voxel to a corresponding point in the voxelized reference point cloud; and outputting, by the one or more processors, a displacement time history of each voxel in the voxelized dynamic point cloud for the structure.

Example 2 relates to the method of Example 1, wherein processing the reference point cloud comprises: applying, by the one or more processors, a density-based spatial clustering algorithm to partition the reference point cloud into clusters based on point density.

Example 3 relates to the method of Example 2, wherein processing the reference point cloud further comprises: setting, by the one or more processors, a minimum number of points per cluster; and setting, by the one or more processors, a predetermined neighborhood search radius for the clustering.

Example 4 relates to the method of any one or more of Examples 1-3, wherein the scanner device comprises a Lidar scanner.

Example 5 relates to the method of Example 4, wherein the scanner device further comprises a vertical mirror and a helical adapter, and wherein controlling the scanner device comprises: operating, by the one or more processors, the scanner in a helical scan mode, wherein each scanline corresponds to a single revolution of the vertical mirror.

Example 6 relates to the method of any one or more of Examples 1-5, further comprising: generating a visual representation of the displacement time history, wherein alerts and recommendations are displayed alongside the visualization for enhanced structural analysis.

Example 7 relates to the method of any one or more of Examples 1-6, further comprising: excluding, by the one or more processors, and from the dynamic response extraction, any voxel having a displacement value exceeding a predetermined threshold.

Example 8 relates to the method of any one or more of Examples 1-7, further comprising: analyzing the displacement time history to estimate structural dynamic parameters, and generating an alert if the estimated parameters deviate from baseline values by more than a predetermined margin.

Example 9 relates to the method of any one or more of Examples 1-8, wherein outputting the displacement time history comprises: transmitting, by the one or more processors, the displacement time history of each voxel to a remote monitoring station via a communication network.

Example 10 relates to the method of any one or more of Examples 1-9, wherein the outputted displacement time history is used to estimate at least one structural dynamic parameter selected from the group consisting of: a natural frequency, a mode shape, and a modal damping ratio.

Example 11 relates to the method of any one or more of Examples 1-10, further comprising: performing, by the one or more processors, the processing of the dynamic point cloud in real time to enable continuous monitoring of the structure.

Example 12 relates to the method of any one or more of Examples 1-11, wherein voxelizing the clustered reference point cloud comprises: partitioning, by the one or more processors, each cluster into a plurality of voxels using a k-neighbor algorithm.

Example 13 relates to the method of any one or more of Examples 1-12, wherein the timestamp is captured with a time resolution of approximately one microsecond.

Example 14 relates to the method of any one or more of Examples 1-13, wherein extracting the dynamic response of each voxel comprises: comparing, by the one or more processors, a median of points in the respective voxel of the voxelized dynamic point cloud to a corresponding median of points in the voxelized reference point cloud.

Example 15 relates to the method of any one or more of Examples 1-14, further comprising: performing, by the one or more processors, an action based on the displacement time history.

Example 16 relates to the method of Example 15, wherein the action comprises one or more of: generating an alert when the displacement value of any voxel exceeds a predetermined threshold, indicating potential structural instability, providing maintenance recommendations based on the displacement time history, wherein the maintenance recommendations include identifying specific areas of the structure requiring reinforcement or further inspection assessing the structural health of the structure based on the displacement time history and generating a use recommendation regarding the continued use or immediate intervention for the structure, generating operational adjustment recommendations for the structure based on the displacement time history, wherein the operational adjustment recommendations include modifying loading conditions or operational parameters to mitigate risks, and using machine learning algorithms to analyze the displacement time history and predict potential failure modes, wherein alerts are generated based on the predictions.

Example 17 relates to the method of any one or more of Examples 1-16, further comprising: generating real-time alerts based on the continuous monitoring of the structure, wherein the real-time alerts are triggered upon detecting abnormal dynamic behavior.

Example 18 relates to the method of any one or more of Examples 1-17, wherein the real-time alerts are transmitted to a remote monitoring station via a communication network.

In Example 19 a non-transitory computer-readable storage medium comprises instructions that, when executed by one or more processors, cause the one or more processors to: control a scanner device to conduct a scan of a plurality of points on a structure; receive, as a result of the scan, a series of scanlines of a field of view of the scanner device, each scanline including a timestamp of an instance of scanning each point of the plurality of points on the structure; generate a dynamic point cloud from the series of scanlines; process a reference point cloud in the dynamic point cloud to cluster the dynamic point cloud based on densities to generate a clustered reference point cloud, wherein the reference point cloud comprises a portion of the dynamic point cloud generated from a first scanline of the series of scanlines; voxelize the clustered reference point cloud to generate a voxelized reference point cloud; use the voxelized reference point cloud to cluster and voxelize a remainder of the dynamic point cloud to generate a voxelized dynamic point cloud; extract a dynamic response of each voxel in the voxelized dynamic point cloud by comparing a point in the respective voxel to a corresponding point in the voxelized reference point cloud; and output a displacement time history of each voxel in the voxelized dynamic point cloud for the structure.

In Example 20, a system comprises a scanner device comprising a Lidar scanner, a vertical mirror, and a helical adapter; and a computing device in communication with the scanner device, the computing device comprising one or more processors to: control the scanner device to conduct a scan of a plurality of points on a structure while operating in a helical scan mode; receive, as a result of the scan, a series of scanlines of a field of view of the scanner device, each scanline including a timestamp of an instance of scanning each point of the plurality of points on the structure; generate a dynamic point cloud from the series of scanlines; process a reference point cloud in the dynamic point cloud to cluster the dynamic point cloud based on densities to generate a clustered reference point cloud, wherein the reference point cloud comprises a portion of the dynamic point cloud generated from a first scanline of the series of scanlines; voxelize the clustered reference point cloud to generate a voxelized reference point cloud; use the voxelized reference point cloud to cluster and voxelize a remainder of the dynamic point cloud to generate a voxelized dynamic point cloud; extract a dynamic response of each voxel in the voxelized dynamic point cloud by comparing a point in the respective voxel to a corresponding point in the voxelized reference point cloud; and output a displacement time history of each voxel in the voxelized dynamic point cloud for the structure.

While multiple examples are disclosed, still other examples will become apparent to those skilled in the art from the following detailed description, which shows and describes illustrative examples. As will be realized, the various implementations are capable of modifications in various obvious aspects, all without departing from the spirit and scope thereof. Accordingly, the drawings and detailed description are to be regarded as illustrative in nature and not restrictive.

### BRIEF DESCRIPTION OF THE DRAWINGS

The following drawings are illustrative of particular examples of the present disclosure and therefore do not limit the scope of the invention. The drawings are not necessarily to scale, though examples can include the scale illustrated, and are intended for use in conjunction with the explanations in the following detailed description wherein like reference characters denote like elements. Examples of the present disclosure will hereinafter be described in conjunction with the appended drawings.

FIG. 1 is a conceptual diagram illustrating a system for dynamic monitoring of structural vibrations using a lidar scanner and computing device, in accordance with one or more of the techniques of this disclosure.

FIG. 2 is a block diagram illustrating a more detailed example of a computing device configured to perform the techniques described herein.

FIG. 3 a system diagram illustrating the setup of a lidar scanner with a vertical mirror and helical adapter for dynamic monitoring, in accordance with one or more of the techniques of this disclosure.

FIG. 4 is a conceptual diagram illustrating a dynamic point cloud, in accordance with one or more of the techniques of this disclosure.

FIG. 5 is a series of graphs illustrating measurements captured by a lidar scanner and analyzed by a computing device, in accordance with one or more of the techniques of this disclosure.

FIG. 6 is a flow diagram illustrating an example method for processing dynamic point clouds to extract displacement time histories, in accordance with one or more of the techniques of this disclosure.

FIG. 7 is a flow diagram illustrating a process for generating displacement time histories from dynamic point clouds using spatial clustering and change detection, in accordance with one or more of the techniques of this disclosure.

### DETAILED DESCRIPTION

The following detailed description is exemplary in nature and is not intended to limit the scope, applicability, or configuration of the techniques or systems described herein in any way. Rather, the following description provides some practical illustrations for implementing examples of the techniques or systems described herein. Those skilled in the art will recognize that many of the noted examples have a variety of suitable alternatives.

Civil infrastructure systems in the United States have heavily deteriorated and nearly $2.6 trillion dollars are needed over the next 10 years for repair, retrofit, and replacement. To prolong the lifespan of infrastructure systems, there is a critical need to monitor the health and condition of structures to facilitate the early diagnosis and repair of damage or degradation (i.e., preventative maintenance). Analysts commonly rely on vibration-based structural health monitoring (SHM) methods to evaluate the operational conditions of structures in service. Accurate field-identified fundamental frequencies and mode shapes of structures are crucial for damage detection and robust finite-element model updating and calibration, which provides valuable information on the structure's condition under different events (i.e., strong earthquakes). For decades, vibration-based SHM methods have greatly relied on discrete contact-based (i.e., wired or wireless) sensors for dynamic monitoring. Despite the success of the traditional sensor-based techniques in monitoring the response of structures, several challenges remain: 1) the sensors need to be placed at discrete locations, which reduces the spatial resolution and may result in spatial aliasing, and 2) the structure of interest needs to be accessed for instrumentation, which may take significant time or may not even be possible due to complex site conditions.

Remote sensing technologies (i.e., laser scanners and vision-based systems) can be employed to provide full-field monitoring data of civil structures for more robust model characterization and updating, and damage detection analysis. Although vision-based frameworks (i.e., using stationary cameras or uncrewed aerial systems (UAS)) have shown promise in conducting full-field monitoring of structures, these frameworks are generally computationally expensive, sensitive to environmental conditions (i.e., illumination, fog, surface preparation), and oftentimes need high-contrast targets to be placed on the structure-of-interest. Alternative vision-based systems can incorporate depth information, such as RGB-D sensors (i.e., Time-of-Flight (ToF) imagers), which have been successfully used to generate dynamic 3D point clouds of laboratory structures for system identification. Furthermore, it is estimated the natural frequencies and mode shapes of a cantilever beam using dynamic 3D point clouds generated using a plenoptic camera (i.e., a camera system that captures the direction of the light entered the camera to make depth measurements).

Ground-Based Lidar (GBL) has been widely used in monitoring the long-term deformation of large civil structures due to the high spatial resolution of the point clouds generated. For instance, the long-term deformations of dams, bridges, and landslides were accurately quantified by comparing point clouds collected at different epochs to a reference point cloud using change detection algorithms and surface reconstruction methods. Despite the great success of lidar in monitoring static deformations, there have been only a few case studies that explored the use of GBL in monitoring the dynamic deformations of civil structures. Studies monitored the dynamic response of a building using a coherent lidar.

Previous studies highlight promising results for quantifying structural vibrations from GBL, however, several research gaps remain. First, GBL-based dynamic monitoring has not been validated beyond a handful of case study structures. To more adequately reflect the range of civil infrastructure, the GBL technique needs to be evaluated across a broad range of dynamic properties that represent typical civil infrastructure systems while using traditional and reliable sensing modalities for validation. Second, the impact of lidar-based variables (i.e., quality, resolution, point-to-point distance) on the accuracy of the results has not been thoroughly investigated. Third, methods for processing dynamic point clouds are few and they do not scale well to different use cases. The techniques described herein address these gaps through the following objectives: 1) validating GBL OMA results using infrared-based sensors and accelerometers; 2) extensively investigating the robustness of GBL-based dynamic monitoring across a range of structures with various dynamic characteristics under different lidar variables; and 3) developing a spatio-temporal framework to autonomously extract the dynamic vibrations of the structure of interest from the dynamic point clouds.

The techniques described herein introduces an autonomous end-to-end framework for monitoring the dynamic response of structures using lidar. The specifications and dynamic monitoring setup of the lidar scanner are described. End-to-end spatial clustering and voxelization as well as change detection algorithms for the processing of dynamic point clouds are proposed.

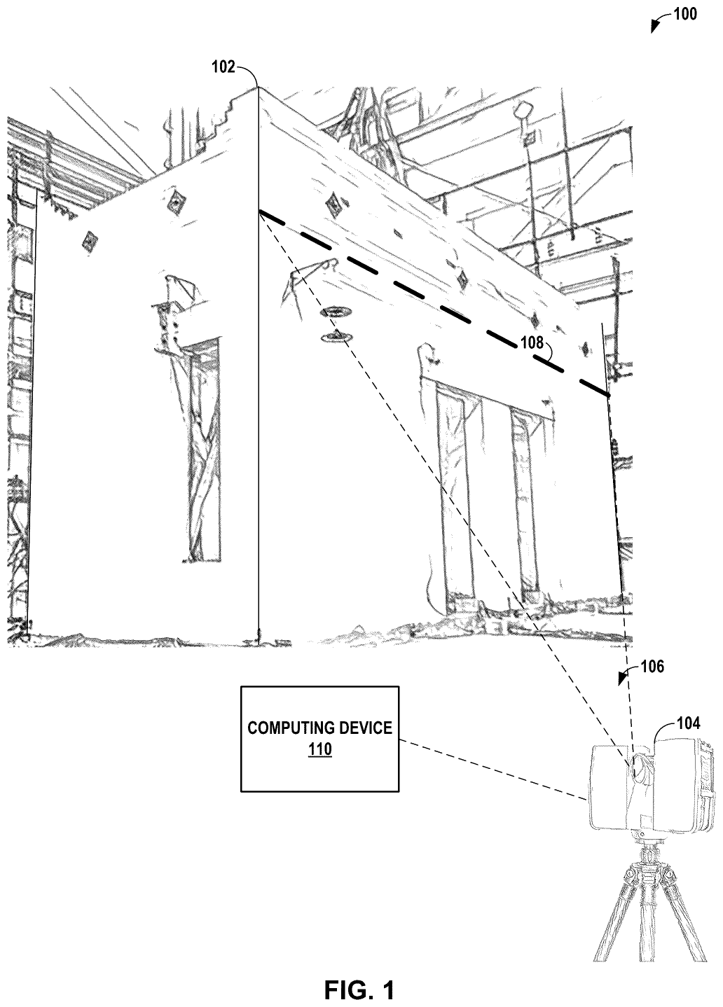

FIG. 1 is a conceptual diagram illustrating a system 100 for dynamic monitoring of structural vibrations using a scanner device 104 and computing device 110, in accordance with one or more of the techniques of this disclosure. The system 100 comprises several interconnected components designed to facilitate remote, continuous, and autonomous monitoring of the dynamic response of structures. Each component contributes to the operation and implementation of the system 100, as described below.

The structure 102 represents the physical object or infrastructure being monitored for dynamic vibrations and deformations. In the context of the described system, the structure 102 can encompass civil infrastructure, such as buildings, bridges, dams, or other large-scale constructions. The structure 102 is exposed to various dynamic forces, such as environmental loads, seismic activity, or operational vibrations, which lead to alterations in physical properties, including mass, damping, and stiffness. These alterations are reflected as observable variations in modal properties, such as natural frequencies, mode shapes, and modal damping ratios.

The structure 102 interacts with the scanner device 104 by reflecting the laser pulses emitted by the scanner device 104. These reflections are captured as dense 3D data points, forming a dynamic point cloud that represents the structure's geometry and dynamic response over time. The structure 102 is typically monitored in full or in specific regions of interest, such as load-bearing elements or areas prone to damage. The described system utilizes the structure 102's ability to reflect laser pulses to generate high-resolution spatial and temporal data for analysis.

The scanner device 104, in some examples, is a Lidar (Light Detection and Ranging) system equipped with a vertical mirror and a helical adapter. The scanner device 104 is responsible for conducting full-field scans of the structure 102 to capture the dynamic response of the structure. The scanner device 104 may operate in a helical scan mode, wherein the vertical mirror rotates continuously to produce sequentially time-stamped 2D point clouds, referred to as scanlines 108. Each scanline 108 corresponds to a single revolution of the vertical mirror and includes timestamped data points representing the geometry and displacement of the structure 102 at specific moments in time.

The scanner device 104 is capable of high spatial resolution and accuracy, with a time resolution of approximately one microsecond. This enables the detection of sub-millimeter displacements and vibrations of the structure 102. The scanner device 104 interacts with the computing device 110 to transmit the captured scanlines 108 for processing and analysis. The helical adapter facilitates continuous scanning without time delay, ensuring real-time data acquisition for continuous monitoring.

The field of view 106 represents the spatial area covered by the scanner device 104 during its operation. The field of view 106 encompasses the structure 102 and any surrounding elements that may be captured in the scanlines 108. The field of view 106 is defined by the operational parameters of the scanner device 104, including range, resolution, and angular increment per point. The rotation of the vertical mirror enables the scanner device 104 to cover an extensive field of view 106, facilitating thorough monitoring of the structure 102.

The field of view 106 plays a significant role in isolating the structure 102 from background elements during the dynamic point cloud processing. Spatial clustering and voxelization algorithms are applied to the field of view 106 to create a higher-level representation of the structure 102, enabling efficient tracking and monitoring of the dynamic response of the structure. The field of view 106 interacts with the scanline 108 to provide a continuous stream of data points for analysis.

The scanline 108 is a sequentially time-stamped 2D point cloud generated by the scanner device 104 during each revolution of the vertical mirror. The scanline 108 represents a slice of the field of view 106 at a specific moment in time, capturing the dynamic response of the structure 102. The scanline 108 includes timestamped data points that are utilized to construct a dynamic point cloud, offering a detailed depiction of the vibrations and deformations of the structure 102 over time.

The scanline 108 is processed using spatial clustering and voxelization algorithms to isolate the structure 102 from background noise and create a voxelized representation of the structure 102. Change detection algorithms are then applied to the scanline 108 to extract the dynamic response of each voxel, resulting in a displacement time history for the structure 102. The scanline 108 interacts with the computing device 110 to facilitate real-time data processing and analysis.

The computing device 110 is responsible for processing the scanlines 108 received from the scanner device 104. The computing device 110 comprises one or more processors and associated memory to execute the spatial clustering, voxelization, and change detection algorithms. These algorithms transform the raw scanlines 108 into a dynamic point cloud, which is then analyzed to extract the displacement time history of the structure 102.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

The computing device 110 interacts with the scanner device 104 to control the operation of the scanner device 104, including initiating scans and adjusting scanning parameters. The computing device 110 also generates visual representations of the displacement time history, which may include alerts and recommendations for improved structural analysis. Additionally, the computing device 110 can transmit the processed data to a remote monitoring station via a communication network, facilitating real-time monitoring and decision-making.

The computing device 110 is designed to operate autonomously, eliminating the need for manual intervention during data acquisition and processing. The scalability and computational efficiency of the computing device 110 make the system 100 suitable for monitoring a wide range of civil infrastructure systems, ensuring robust and accurate structural health monitoring.

In accordance with the techniques described herein, computing device 110 may control scanner device 104 to conduct a scan of a plurality of points on structure 102. Computing device 110 may receive, as a result of the scan, a series of scanlines of a field of view of the scanner device, each scanline including a timestamp of an instance of scanning each point of the plurality of points on the structure. Computing device 110 may generate a dynamic point cloud from the series of scanlines. Computing device 110 may process a reference point cloud in the dynamic point cloud to cluster the dynamic point cloud based on densities to generate a clustered reference point cloud, wherein the reference point cloud comprises a portion of the dynamic point cloud generated from a first scanline of the series of scanlines. Computing device 110 may voxelize the clustered reference point cloud to generate a voxelized reference point cloud. Computing device 110 may use the voxelized reference point cloud to cluster and voxelize a remainder of the dynamic point cloud to generate a voxelized dynamic point cloud. Computing device 110 may extract a dynamic response of each voxel in the voxelized dynamic point cloud by comparing a point in the respective voxel to a corresponding point in the voxelized reference point cloud. Computing device 110 may output a displacement time history of each voxel in the voxelized dynamic point cloud for the structure.

The monitoring of dynamic vibrations in civil structures plays an important role in structural health monitoring (SHM), facilitating the early identification of damage and degradation. Conventional vibration-based SHM methods often depend on contact-based sensors, such as wired or wireless accelerometers, installed at specific locations on the structure. Although these methods can be effective, they face several challenges, including limited spatial resolution due to the discrete placement of sensors, the requirement for physical access to the structure for installation, and the computational effort involved in processing data from multiple sensors. Additionally, these approaches may be unsuitable for large-scale or complex structures, such as bridges or dams, where sensor installation can be hazardous or impractical. Vision-based systems, while providing non-contact monitoring, are influenced by environmental conditions, require high-contrast targets, and often involve computationally intensive processing, which can affect their scalability and dependability.

The present framework addresses these limitations by introducing a novel approach for remotely monitoring the dynamic vibrations of structures using Lidar-based dynamic point cloud processing. This approach utilizes the capabilities of GBL to generate dense, time-stamped 2D point clouds of the structure's field of view, enabling comprehensive monitoring without requiring physical access or discrete sensor placement. To address the computational challenges associated with processing dense Lidar data, the framework employs a two-step spatio-temporal algorithm. First, the algorithm applies density-based spatial clustering (DBSCAN) to partition the reference point cloud into clusters based on spatial density, followed by voxelization using a k-neighbor algorithm to create a high-level representation of the structure. Second, a change detection algorithm tracks the median displacement of each voxel over time, generating a displacement time history for the structure. This approach ensures robust dynamic response extraction while mitigating the impact of noise present in Lidar data.

By enabling remote, continuous, and autonomous monitoring of structural vibrations, the described framework offers significant advantages over conventional methods. The approach removes the need for physical sensor installation, reducing costs and improving safety, particularly for inaccessible or hazardous structures. The clustering and voxelization processes optimize data analysis, enabling faster and more scalable computation without compromising accuracy. Furthermore, the framework's capability to detect sub-millimeter vibrations and estimate modal properties, such as natural frequencies and mode shapes, makes the system applicable to a wide range of fields, including infrastructure monitoring, aerospace, military, and autonomous vehicle systems. This framework represents a transformative advancement in structural health monitoring, providing a cost-effective, scalable, and safer solution for dynamic monitoring of civil structures.

The techniques described herein are directed to a method and system for monitoring the dynamic response of structures using lidar scanning and dynamic point cloud processing. The techniques described herein integrate advanced algorithms, hardware configurations, and data processing techniques to solve a specific technical problem: the limitations of conventional structural health monitoring (SHM) systems in providing full-field, high-resolution, and remote dynamic monitoring of civil structures. The techniques described herein constitute a practical application of technology to improve the monitoring and analysis of structural dynamics.

Conventional SHM systems rely on contact-based sensors, which are limited in spatial resolution, require physical access to the structure, and are often impractical for large-scale or hazardous structures. Vision-based systems, while non-contact, are computationally expensive and sensitive to environmental conditions. These limitations hinder the ability to perform comprehensive, real-time monitoring of structural vibrations and dynamic behavior. The invention addresses these challenges by leveraging lidar scanning and dynamic point cloud processing to provide remote, continuous, and autonomous monitoring of structures.

The techniques described herein apply lidar technology to generate dense, time-stamped point clouds of a structure's field of view. It introduces a two-step spatio-temporal algorithm that combines density-based spatial clustering and voxelization to efficiently process the point cloud data. The change detection algorithm extracts dynamic responses of the structure, enabling the generation of displacement time histories and the estimation of modal properties such as natural frequencies and mode shapes. These outputs are used to assess structural health, detect damage, and provide actionable insights, such as alerts and recommendations for maintenance or operational adjustments.

Additionally, the techniques described herein reduce the amount of processing typically required of such systems. For instance, generating a voxelized dynamic point cloud is a computationally heavy process when clustering and voxelizing a dynamic point cloud from the raw data. By only doing this process once on a reference point cloud and then calculating the clustered and voxelized version of the remainder of the dynamic point cloud using the reference point cloud as a reference, the amount of processing needed to ultimately generate the displacement time history is greatly reduced, thereby improving the computer and the computing environment in and of itself when processing this data. Furthermore, by producing alerts and recommendations for maintenance, use, or operational adjustments, the techniques described herein include non-generic computing devices and do significantly more than simply process data.

The techniques described herein provide significant improvements over conventional SHM methods by eliminating the need for physical sensor installation, reducing costs and improving safety, enabling full-field monitoring with high spatial and temporal resolution, capturing sub-millimeter vibrations, automating the processing of dense lidar data, ensuring scalability and computational efficiency, and supporting real-time monitoring and analysis, facilitating rapid decision-making for structural integrity assessments. The techniques described herein integrate hardware components, such as a lidar scanner operating in helical scan mode, with software algorithms for clustering, voxelization, and change detection. This combination of hardware and software creates a functional system that transforms raw lidar data into meaningful dynamic information, demonstrating a practical application of technology to solve a real-world problem.

The techniques described herein are rooted in the technological field of structural health monitoring and remote sensing. It is applicable to a wide range of industries, including infrastructure, aerospace, military, and autonomous systems. The disclosed techniques provide tangible benefits, such as improved safety, reduced costs, and enhanced scalability, making the invention a valuable contribution to the field. As such, the techniques described herein are directed to a specific, practical application of lidar technology and dynamic point cloud processing to address the limitations of conventional SHM systems.

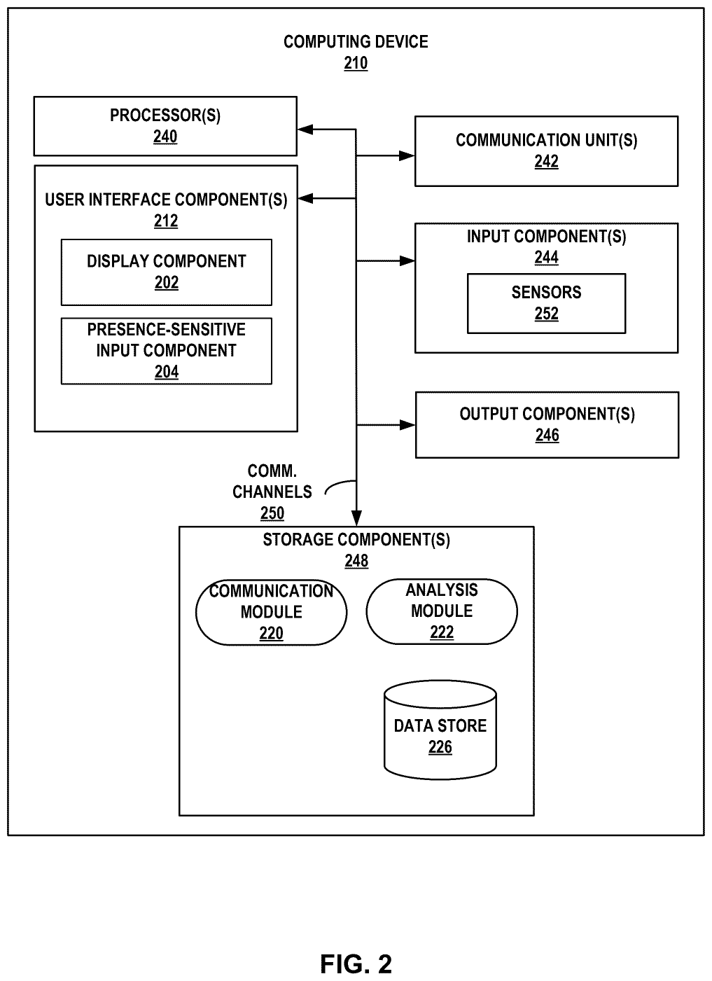

FIG. 2 is a block diagram illustrating a more detailed example of a computing device configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), an integrated computer system, a vehicle, a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface components (UIC) 212, one or more processors 240, one or more communication units 242, one or more input components 244, one or more output components 246, and one or more storage components 248. UIC 212 includes display component 202 and presence-sensitive input component 204. Storage components 248 of computing device 210 include communication module 220, analysis module 222, and data store 226.

One or more processors 240 may implement functionality and/or execute instructions associated with computing device 210 to determine structural integrity of a structure based on lidar scans. That is, processors 240 may implement functionality and/or execute instructions associated with computing device 210 to process dynamic point clouds to generate displacement time histories that indicate vibration levels and structural integrity along a scanline.

Examples of processors 240 include any combination of application processors, display controllers, auxiliary processors, one or more sensor hubs, and any other hardware configured to function as a processor, a processing unit, or a processing device, including dedicated graphical processing units (GPUs). Modules 220 and 222 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222. The instructions, when executed by processors 240, may cause computing device 210 to process dynamic point clouds to generate displacement time histories that indicate vibration levels and structural integrity along a scanline.

Communication module 220 may execute locally (e.g., at processors 240) to provide functions associated with controlling and communicating with a scanner device, such as a lidar scanner, and outputting alerts, recommendations, and reports to a user interface. In some examples, communication module 220 may act as an interface to a remote service accessible to computing device 210. For example, communication module 220 may be an interface or application programming interface (API) to a remote server that controls and communicates with a scanner device, such as a lidar scanner, and outputs alerts, recommendations, and reports to a user interface.

In some examples, analysis module 222 may execute locally (e.g., at processors 240) to provide functions associated with analyzing the scans to develop a displacement time history. In some examples, analysis module 222 may act as an interface to a remote service accessible to computing device 210. For example, analysis module 222 may be an interface or application programming interface (API) to a remote server that analyzes the scans to develop a displacement time history.

One or more storage components 248 within computing device 210 may store information for processing during operation of computing device 210 (e.g., computing device 210 may store data accessed by modules 220 and 222 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222 and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g., such as an Ethernet card), an optical transceiver, a radio frequency transceiver, a GPS receiver, a radio-frequency identification (RFID) transceiver, a near-field communication (NFC) transceiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, include a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras), one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a radar sensor, a lidar sensor, a sonar sensor, a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, include a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UIC 212 of computing device 210 may include display component 202 and presence-sensitive input component 204. Display component 202 may be a screen, such as any of the displays or systems described with respect to output components 246, at which information (e.g., a visual indication) is displayed by UIC 212 while presence-sensitive input component 204 may detect an object at and/or near display component 202.

While illustrated as an internal component of computing device 210, UIC 212 may also represent an external component that shares a data path with computing device 210 for transmitting and/or receiving input and output. For instance, in one example, UIC 212 represents a built-in component of computing device 210 located within and physically connected to the external packaging of computing device 210 (e.g., a screen on a mobile phone). In another example, UIC 212 represents an external component of computing device 210 located outside and physically separated from the packaging or housing of computing device 210 (e.g., a monitor, a projector, etc. that shares a wired and/or wireless data path with computing device 210).

UIC 212 of computing device 210 may detect two-dimensional and/or three-dimensional gestures as input from a user of computing device 210. For instance, a sensor of UIC 212 may detect a user's movement (e.g., moving a hand, an arm, a pen, a stylus, a tactile object, etc.) within a threshold distance of the sensor of UIC 212. UIC 212 may determine a two or three-dimensional vector representation of the movement and correlate the vector representation to a gesture input (e.g., a hand-wave, a pinch, a clap, a pen stroke, etc.) that has multiple dimensions. In other words, UIC 212 can detect a multi-dimension gesture without requiring the user to gesture at or near a screen or surface at which UIC 212 outputs information for display. Instead, UIC 212 can detect a multi-dimensional gesture performed at or near a sensor which may or may not be located near the screen or surface at which UIC 212 outputs information for display.

In accordance with the techniques of this disclosure, communication module 220 may control a scanner device to conduct a scan of a plurality of points on a structure. In some instances, the scanner device may be a Lidar scanner. In some such instances, the scanner device further includes a vertical mirror and a helical adapter, and, when controlling the scanner device, communication module 220 may operate the scanner in a helical scan mode, wherein each scanline corresponds to a single revolution of the vertical mirror.

Communication module 220 may receive, as a result of the scan, a series of scanlines of a field of view of the scanner device, each scanline including a timestamp of an instance of scanning each point of the plurality of points on the structure. In some instances, the timestamp is captured with a time resolution of approximately one microsecond.

Analysis module 222 may generate a dynamic point cloud from the series of scanlines. Analysis module 222 may process a reference point cloud in the dynamic point cloud to cluster the dynamic point cloud based on densities to generate a clustered reference point cloud, wherein the reference point cloud comprises a portion of the dynamic point cloud generated from a first scanline of the series of scanlines. In some instances, in processing the reference point cloud, analysis module 222 may apply a density-based spatial clustering algorithm to partition the reference point cloud into clusters based on point density. In some such instances, analysis module 222 may set a minimum number of points per cluster and a predetermined neighborhood search radius for the clustering.

In some instances, analysis module 222 may perform the processing of the dynamic point cloud in real time to enable continuous monitoring of the structure.

Analysis module 222 may voxelize the clustered reference point cloud to generate a voxelized reference point cloud. In some instances, when voxelizing the clustered reference point cloud, analysis module 222 may partition each cluster into a plurality of voxels using a k-neighbor algorithm.

Analysis module 222 may use the voxelized reference point cloud to cluster and voxelize a remainder of the dynamic point cloud to generate a voxelized dynamic point cloud. Analysis module 222 may extract a dynamic response of each voxel in the voxelized dynamic point cloud by comparing a point in the respective voxel to a corresponding point in the voxelized reference point cloud. In some instances, when extracting the dynamic response of each voxel, analysis module 222 may compare a median of points in the respective voxel of the voxelized dynamic point cloud to a corresponding median of points in the voxelized reference point cloud.

In some instances, analysis module 222 may exclude, from the dynamic response extraction, any voxel having a displacement value exceeding a predetermined threshold.

Communication module 220 may output a displacement time history of each voxel in the voxelized dynamic point cloud for the structure. In some instances, when outputting the displacement time history, communication module 220 may transmit the displacement time history of each voxel to a remote monitoring station via a communication network.

In some instances, analysis module 222 may generate a visual representation of the displacement time history, wherein alerts and recommendations are displayed alongside the visualization for enhanced structural analysis. In some such instances, the alerts and recommendations are transmitted to a remote monitoring station by communication module 220 via a communication network.

In some instances, the outputted displacement time history is used to estimate at least one structural dynamic parameter, such as a natural frequency, a mode shape, and/or a modal damping ratio.

In some instances, communication module 220 may perform an action based on the displacement time history. The action may consist of any one or more of communication module 220 generating an alert (e.g., an audible visual, or tactile alert) when the displacement value of any voxel exceeds a predetermined threshold, indicating potential structural instability, communication module 220 providing maintenance recommendations based on the displacement time history, wherein the maintenance recommendations include identifying specific areas of the structure requiring reinforcement or further inspection, communication module 220 assessing the structural health of the structure based on the displacement time history and generating a use recommendation regarding the continued use or immediate intervention for the structure, communication module 220 generating operational adjustment recommendations for the structure based on the displacement time history, wherein the operational adjustment recommendations include modifying loading conditions or operational parameters to mitigate risks, and communication module 220 using machine learning algorithms to analyze the displacement time history and predict potential failure modes, wherein alerts are generated based on the predictions.

In some instances, analysis module 222 may analyze the displacement time history to estimate structural dynamic parameters. In such instances, communication module 220 may generate an alert if the estimated parameters deviate from baseline values by more than a predetermined margin.

In some instances, communication module 220 may generate real-time alerts based on the continuous monitoring of the structure, wherein the real-time alerts are triggered upon detecting abnormal dynamic behavior.

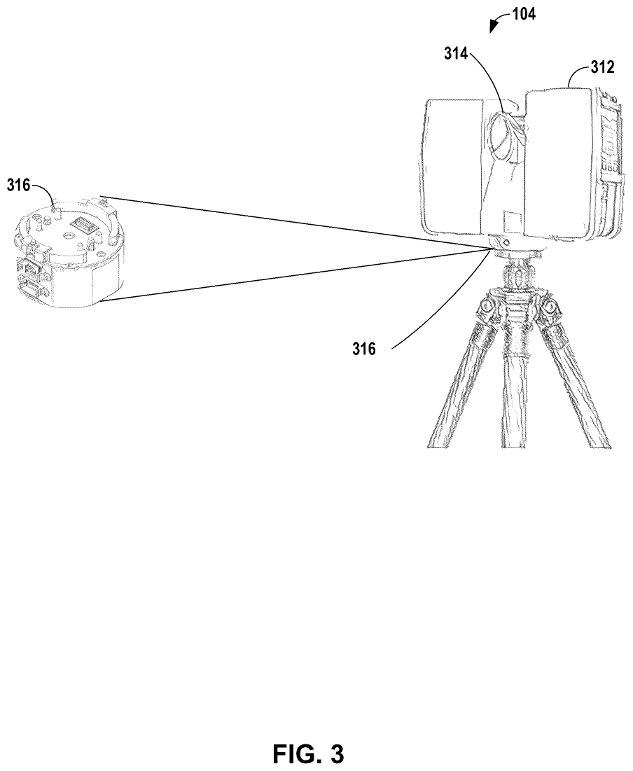

FIG. 3 a system diagram illustrating an example setup of scanning device 104 as a lidar scanner 312 with a vertical mirror 314 and helical adapter 316 (shown both in exploded view and as integrated into the overall device) for dynamic monitoring, in accordance with one or more of the techniques of this disclosure. The Lidar scanner 312 is a remote sensing device that utilizes pulsed laser light to measure distances and generate high-resolution three-dimensional point clouds of the scanned environment. In this context, the Lidar scanner 312 is employed to conduct dynamic monitoring of structures, capturing their vibrational responses with high spatial and temporal resolution. The Lidar scanner 312 is equipped with advanced optics and sensors capable of detecting sub-millimeter displacements, making the device suitable for applications in structural health monitoring (SHM). The scanner operates in conjunction with the vertical mirror 314 and the helical adapter 316 to facilitate continuous line-based scanning without time delay, enabling real-time data acquisition. The Lidar scanner 312 is configured to generate sequentially time-stamped 2D point clouds, which are processed to extract dynamic information about the structure under observation. The scanner's sampling frequency is determined by the rotational speed of the vertical mirror 314, and its range and field of view are optimized for monitoring large-scale structures. The Lidar scanner 312 interacts with the vertical mirror 314 and helical adapter 316 to produce helical scan files, which are subsequently processed using spatial clustering and voxelization algorithms to isolate the structure of interest from background noise.

The vertical mirror 314 is a component of the Lidar scanner 312 that facilitates the scanning process by rotating vertically to direct the laser beam across the field of view. The vertical mirror 314 operates within a fixed horizontal angle, enabling the generation of helical scanlines that correspond to the total number of revolutions of the mirror per second. This configuration allows for uninterrupted dynamic monitoring of structures, as each scanline represents a complete revolution of the vertical mirror 314. The vertical mirror 314 is designed to achieve a field of view ranging from as wide as −150° to +150°, ensuring broad coverage of the scanned area. The rotational motion of the vertical mirror 314 is precisely controlled to maintain the accuracy and resolution of the generated point clouds. The interaction between the vertical mirror 314 and the Lidar scanner 312 is integral to producing time-stamped scanlines, which are later processed to extract displacement time histories of the structure. The vertical mirror 314's ability to operate in helical scan mode enhances the scanner's capability to monitor dynamic vibrations remotely and continuously.

The helical adapter 316 is a specialized attachment that enables the Lidar scanner 312 and vertical mirror 314 to operate in helical scan mode. The helical adapter 316 restricts the vertical mirror 314 to rotate vertically while maintaining a fixed horizontal angle, thereby facilitating the generation of helical scanlines. This mode of operation is particularly advantageous for dynamic monitoring applications, as it eliminates time delays and ensures continuous data acquisition. The helical adapter 316 is designed to be robust and compatible with the Lidar scanner 312, allowing for seamless integration and operation. The helical adapter 316 is integral to the spatial clustering and voxelization processes, as the adapter ensures the consistency of the scanlines, which are used as reference point clouds for subsequent data processing. By enabling the helical scan mode, the helical adapter 316 enhances the scalability and efficiency of the monitoring framework, making the framework suitable for a wide range of civil infrastructure systems. The helical adapter 316 interacts with the Lidar scanner 312 and vertical mirror 314 to produce dynamic point clouds that are processed to extract meaningful structural vibration data.

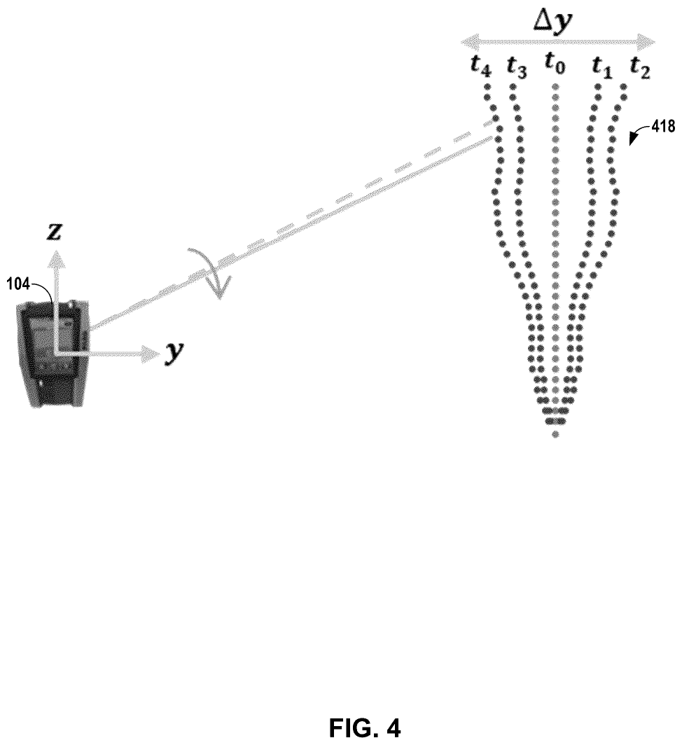

FIG. 4 is a conceptual diagram illustrating a dynamic point cloud 418, in accordance with one or more of the techniques of this disclosure. Scanner device 104 serves as an integral part of the system for conducting remote structural health monitoring. The scanner device 104 is configured to perform a scan of multiple points on a structure, such as the structure 102, within the field of view 106 (from FIG. 1). The scanner device 104 operates in a helical scan mode, facilitated by the integration of a vertical mirror 314 and a helical adapter 316, as illustrated in FIG. 3. The helical scan mode allows for uninterrupted line-based scanning without time delay, supporting dynamic monitoring of the structure. Each scanline 108 produced by the scanner device 104 corresponds to a single revolution of the vertical mirror 314, and the scanlines are time-stamped with a resolution of approximately one microsecond to provide accurate temporal tracking of the scanned points.

The scanner device 104 generates a series of scanlines that serve as the foundation for a dynamic point cloud 418, as illustrated in FIG. 4. The dynamic point cloud 418 represents scanned points with associated timestamps, capturing structural vibrations and displacements over time. The scanner device 104 is designed to detect sub-millimeter structural vibrations, making the device appropriate for monitoring ambient vibrations of structures in the field. The scanner device 104 interacts with the computing device 110 to transmit the scanlines and additional data for further processing.

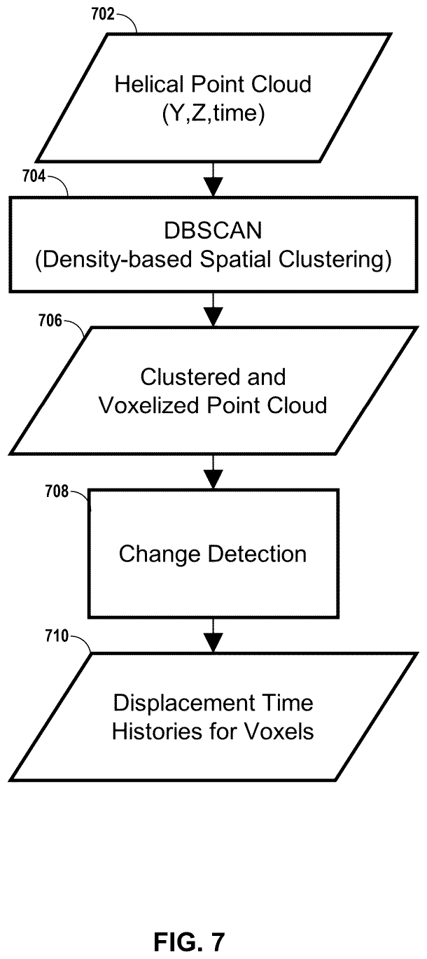

The dynamic point cloud 418 is generated from the series of scanlines received from the scanner device 104. The dynamic point cloud 418 represents the spatial and temporal data of the scanned points on the structure 102, capturing the dynamic response of the structure over time. Each point in the dynamic point cloud 418 is associated with a timestamp, allowing for precise tracking of structural vibrations. The dynamic point cloud 418 is processed using a two-step spatio-temporal algorithm, as detailed in FIG. 7, to extract meaningful data from the dense point cloud.

The first step involves spatial clustering and voxelization of the dynamic point cloud 418 using the DBSCAN algorithm 704 and the KNN algorithm 706. This process partitions the dynamic point cloud 418 into clusters and voxels, creating a higher-level representation of the data. The second step involves change detection 708, where the dynamic response of each voxel is extracted by comparing the median of points in the voxel at a given time to the corresponding median in a reference voxelized point cloud. The final output is a displacement time history 710 for each voxel, which provides meaningful observations regarding the structural dynamics.

The dynamic point cloud 418 is utilized to estimate structural dynamic parameters such as natural frequency, mode shape, and modal damping ratio. This approach facilitates real-time alerts and recommendations for improved structural analysis, as outlined in the claims.

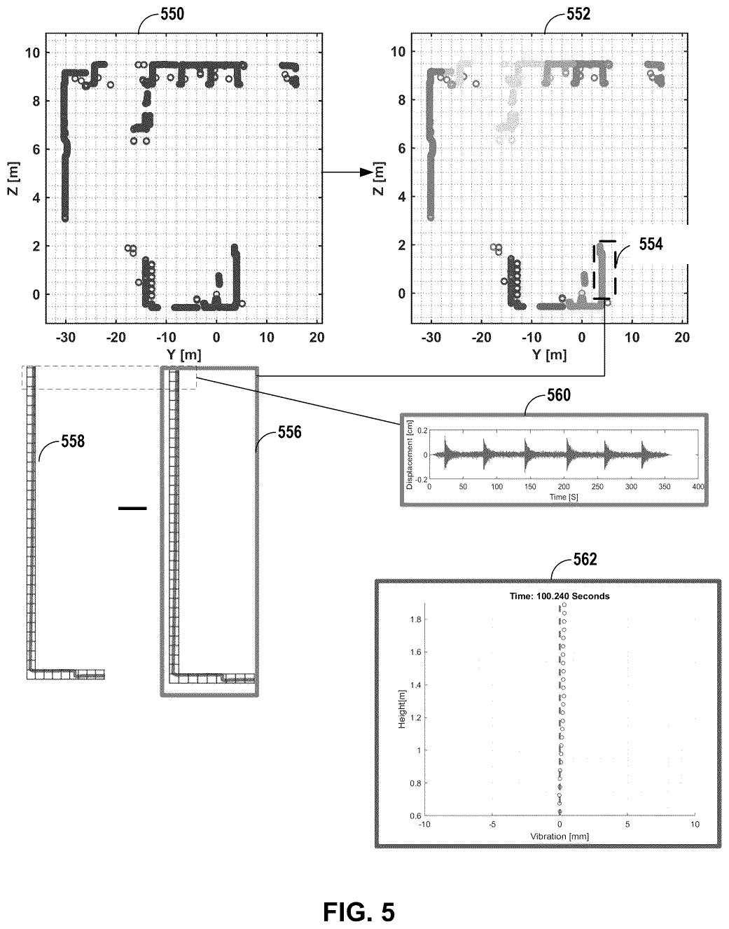

FIG. 5 is a series of graphs illustrating measurements captured by a lidar scanner and analyzed by a computing device, in accordance with one or more of the techniques of this disclosure. The 2D point cloud 550 represents the raw data acquired by the Lidar scanner during a helical scan. Each point in the 2D point cloud 550 corresponds to a timestamped measurement of the structure's geometry, captured in the scanner's field of view. The 2D point cloud 550 is organized in a Cartesian coordinate system, where the Y-axis represents the horizontal distance from the scanner, and the Z-axis represents the height of the measured points. This component serves as the foundational dataset for subsequent processing steps, including spatial clustering and voxelization.

The 2D point cloud 550 is generated continuously during the helical scan, ensuring that each point is associated with a precise timestamp. This timestamp enables the dynamic monitoring of the structure by correlating spatial data with temporal information. The resolution and density of the 2D point cloud 550 are influenced by scanner parameters such as angular increment, quality settings, and the scanner's standoff distance from the structure. These parameters play a significant role in ensuring the accuracy and reliability of the data, particularly in applications requiring sub-millimeter precision.

The 2D point cloud 550 interacts with subsequent components, such as the clustered point cloud 552, by serving as the input dataset for spatial clustering algorithms. The raw data in the 2D point cloud 550 is processed to isolate the structure of interest from background noise and irrelevant data points. This isolation is achieved through density-based spatial clustering techniques, which partition the 2D point cloud 550 into meaningful clusters based on point density and spatial proximity.

The clustered point cloud 552 is derived from the 2D point cloud 550 through the application of spatial clustering algorithms, such as the Density-Based Spatial Clustering of Applications with Noise (DBSCAN). The clustered point cloud 552 organizes the raw data into distinct clusters, each representing a specific segment of the structure. This clustering process plays a significant role in isolating the structure of interest from background noise and irrelevant data points, thereby enabling more focused analysis of the dynamic response.

Each cluster in the clustered point cloud 552 is defined by a set of hyperparameters, including the minimum number of points per cluster and the neighborhood search radius. These parameters are tailored to the spatial density of the 2D point cloud 550 and the geometric characteristics of the structure being monitored. The clustered point cloud 552 facilitates the identification of structural features and regions of interest, which are subsequently processed for voxelization and dynamic response analysis.

The clustered point cloud 552 interacts with the segment 554 by providing the spatially organized data required for partitioning the structure into smaller, manageable units. This interaction ensures that the dynamic response of each segment can be accurately tracked and analyzed. Additionally, the clustered point cloud 552 serves as the input for voxelization algorithms, which further refine the data representation by dividing each cluster into three-dimensional grid cells, or voxels.

The segment 554 represents a specific portion of the clustered point cloud 552 that has been isolated for detailed analysis. Each segment is defined by its spatial boundaries within the clustered point cloud 552 and corresponds to a distinct structural feature or region of interest. The segmentation process plays an important role in enabling localized analysis of the dynamic response, as this process facilitates the division of the structure into smaller, more manageable units.

The segment 554 is processed using voxelization techniques to create a higher-level data representation. This representation facilitates the tracking and monitoring of dynamic displacements within the segment. The segment 554 interacts with the reference voxelization 556 by serving as the input dataset for voxelization algorithms. These algorithms partition the segment into a regular three-dimensional grid, enabling precise tracking of structural vibrations and changes over time.

The reference voxelization 556 is a three-dimensional grid representation of the clustered point cloud 552, specifically focusing on the initial reference frame of the structure. This component is generated by applying voxelization algorithms, such as the k-nearest neighbor (KNN) algorithm, to the clustered point cloud 552. The reference voxelization 556 serves as the baseline for dynamic response analysis, as this representation provides a stable, high-resolution depiction of the structure's geometry at time $t=0$.

Each voxel in the reference voxelization 556 is defined by its spatial boundaries and contains a subset of points from the clustered point cloud 552. The voxelization process excludes noise clusters identified during the spatial clustering step, ensuring that only relevant structural data is included. The reference voxelization 556 interacts with the other voxelization 558 by providing the baseline data required for change detection algorithms. These algorithms compare the dynamic response of each voxel in the other voxelization 558 to the corresponding voxel in the reference voxelization 556, enabling the quantification of structural vibrations and displacements.

The other voxelization 558 represents the dynamic voxelized point cloud generated from the remainder of the clustered point cloud 552, excluding the reference frame. This component is created by applying voxelization algorithms to the dynamic point cloud, ensuring that each voxel corresponds to a specific region of the structure at a given timestamp. The other voxelization 558 is used to track the dynamic response of the structure over time, providing a detailed representation of structural vibrations and changes.

Each voxel in the other voxelization 558 is compared to the corresponding voxel in the reference voxelization 556 using change detection algorithms. These algorithms calculate the dynamic displacement of each voxel by analyzing the median of points within the voxel at different timestamps. The other voxelization 558 interacts with the voxel dynamic response 560 by serving as the input dataset for dynamic response extraction. This interaction facilitates the generation of displacement time histories for each voxel, which are necessary for structural health monitoring and dynamic analysis.

The voxel dynamic response 560 represents the displacement time history of each voxel in the other voxelization 558. This component is generated by applying change detection algorithms to the dynamic voxelized point cloud, comparing the median of points within each voxel to the corresponding voxel in the reference voxelization 556. The voxel dynamic response 560 provides a detailed temporal record of structural vibrations and displacements, enabling the analysis of dynamic behavior at a high spatial resolution.

The voxel dynamic response 560 is used to identify abnormal dynamic behavior, such as excessive displacements or deviations from baseline values. This component interacts with the full-field response 562 by contributing localized displacement data to the overall dynamic analysis of the structure. The voxel dynamic response 560 plays an important role in applications such as damage detection, finite element model updating, and operational modal analysis, as the granular data provided supports these tasks.

The full-field response 562 represents the aggregated dynamic behavior of the entire structure, as derived from the voxel dynamic response 560. This component provides a comprehensive visualization of structural vibrations and displacements, enabling analysts to assess the overall integrity and dynamic performance of the structure. The full-field response 562 is generated by combining the displacement time histories of all voxels in the other voxelization 558, creating a unified representation of the structure's dynamic response.

The full-field response 562 is used to identify global patterns of dynamic behavior, such as mode shapes, natural frequencies, and modal damping ratios. This component interacts with the voxel dynamic response 560 by integrating localized displacement data into the overall analysis. The full-field response 562 plays a significant role in applications such as structural health monitoring, damage detection, and operational modal analysis, as the data it provides supports the high-level insights necessary for these tasks.

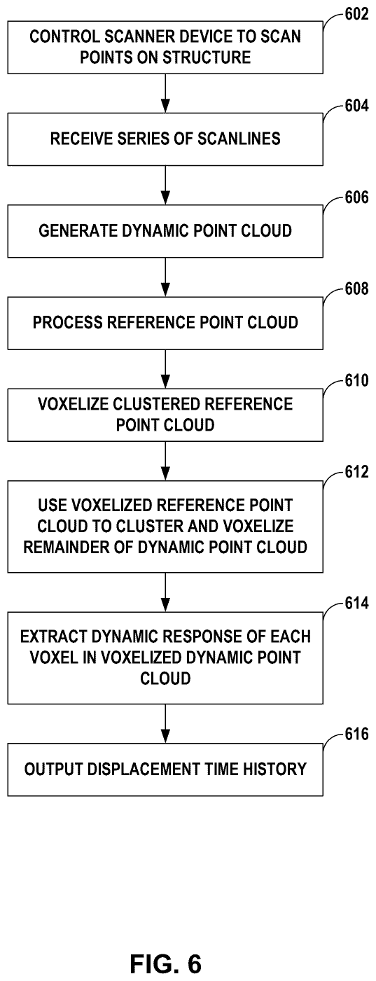

FIG. 6 is a flow diagram illustrating an example method for processing dynamic point clouds to extract displacement time histories, in accordance with one or more of the techniques of this disclosure. The techniques of FIG. 6 may be performed by one or more processors of a computing device, such as system 100 of FIG. 1 and/or computing device 210 illustrated in FIG. 2. For purposes of illustration only, the techniques of FIG. 6 are described within the context of computing device 210 of FIG. 2, although computing devices having configurations different than that of computing device 210 may perform the techniques of FIG. 6.

In accordance with the techniques of this disclosure, communication module 220 controls a scanner device to conduct a scan of a plurality of points on a structure (602). Communication module 220 receives, as a result of the scan, a series of scanlines of a field of view of the scanner device, each scanline including a timestamp of an instance of scanning each point of the plurality of points on the structure (604). Analysis module 222 generates a dynamic point cloud from the series of scanlines (606). Analysis module 222 processes a reference point cloud in the dynamic point cloud to cluster the dynamic point cloud based on densities to generate a clustered reference point cloud, wherein the reference point cloud comprises a portion of the dynamic point cloud generated from a first scanline of the series of scanlines (608). Analysis module 222 voxelizes the clustered reference point cloud to generate a voxelized reference point cloud (610). Analysis module 222 uses the voxelized reference point cloud to cluster and voxelize a remainder of the dynamic point cloud to generate a voxelized dynamic point cloud (612). Analysis module 222 extracts a dynamic response of each voxel in the voxelized dynamic point cloud by comparing a point in the respective voxel to a corresponding point in the voxelized reference point cloud (614). Communication module 220 outputs a displacement time history of each voxel in the voxelized dynamic point cloud for the structure (616).

FIG. 7 is a flow diagram illustrating a process for generating displacement time histories from dynamic point clouds using spatial clustering and change detection, in accordance with one or more of the techniques of this disclosure. The techniques of FIG. 7 may be performed by one or more processors of a computing device, such as system 100 of FIG. 1 and/or computing device 210 illustrated in FIG. 2. For purposes of illustration only, the techniques of FIG. 7 are described within the context of computing device 210 of FIG. 2, although computing devices having configurations different than that of computing device 210 may perform the techniques of FIG. 7.

In accordance with the techniques of this disclosure, novel two-step spatio-temporal algorithm was developed to identify and extract the structural vibration information from the background scene within the helical scan files (i.e., dynamic point clouds). The algorithm starts with obtaining a helical dynamic point cloud (702). The algorithm proceeds with spatial clustering and voxelization (704), where voxelization is the process of partitioning the point cloud into a regular three-dimensional grid to facilitate point tracking and monitoring. Each partition of this three-dimensional grid is referred to as a voxel. This results in a clustered and voxelized point cloud (706). Then, a change detection algorithm (708) extracts the dynamic response of each voxel which is a displacement time history at a given point on the structure (710). A dynamic point cloud is an array of sequentially time-stamped 2D point clouds, where clustering and voxelization of each 2D point cloud independently is computationally very demanding. To cluster and voxelize the entire dynamic point cloud efficiently, the described algorithm relies on clustering and voxelizing a reference point cloud (i.e., 2D point cloud at time t=0) rather than processing every 2D point cloud in the dynamic point cloud independently. It can be assumed that real-world civil structures typically do not undergo large rigid-body displacements. Hence, it is expected that structural vibrations (i.e., small dynamic displacements relative to the structure's geometry) will not lead to significant changes with respect to the distance between the structure-of-interest and GBL during dynamic monitoring. Therefore, the algorithm assumes that the row indices of the datapoints of the structure-of-interest are nearly identical across all the 2D point clouds generated over the duration of the test, which justifies clustering and voxelizing the entire dynamic point cloud based on the initial reference point cloud. For simplicity, each row in a 2D point cloud can be envisioned as a single lidar channel that measures the distance to a point in space.

For the algorithm that clusters and voxelizes the reference point cloud, the Density-based Spatial Clustering of Applications with Noise (DBSCAN) algorithm is utilized to partition the point cloud into clusters based on spatial density. The DBSCAN algorithm is suitable and robust for large spatial databases with noise. Then, each of the point cloud's clusters is further partitioned into voxels using the k-nearest neighbor (KNN) algorithm. The voxelization step excludes the noise clusters determined by the DBSCAN algorithm. The clustering and voxelization processes are highly dependent on the minimum number of points per cluster/voxel and the neighborhood search radius. These hyperparameters can be set by the analyst based on the spatial density of the dynamic point cloud in the vicinity of the structure-of-interest. The minimum number of points per cluster and voxel may be any suitable number (e.g., 5), and the neighborhood search radii were 30 and 5 cm for clustering and voxelization, respectively, although other radii could also be used for this process. These parameters may be determined based on the size of the structure and scanner-based parameters considered. The spatial clustering and voxelization steps create a higher level of data representation for the 2D point clouds, which allows analysts to smoothly isolate the structure-of-interest from the background. Analysts can use voxels along the structure-of-interest to individually study the dynamic response of any part of the structure-of-interest for a careful assessment of the overall structural integrity at a high spatial resolution. The proposed spatial clustering and voxelization algorithm is computationally efficient and easily scalable to monitor a wide range of civil infrastructure systems.

Spatial clustering and voxelization algorithm, where Clus_idx: cluster indices of each data point in the reference point cloud (Ref_PC), ε: neighborhood search radius for clustering, Min_pts: minimum number of neighbors to identify a core point in each cluster, N_Clus: number of clusters in Ref_PC, Vox_Min_Pts: minimum number of points in each voxel, Vox_idx: voxel indices of each data point in each cluster, εvox: neighborhood search radius for voxelization, and Core_Pt: core point in each voxel.

The cluster and voxel indices of each datapoint in the reference 2D point cloud are used to cluster and voxelize the entire dynamic point cloud efficiently. To extract the dynamic response of each voxel (i.e., change detection), the median of the points in a voxel at any time “t” is compared to the corresponding point in the reference frame (i.e., 2D point cloud at time t=0) to quantify the dynamic motion. Only the medians of the voxels may be tracked in the change detection step, rather than all of the voxel points, to make the dynamic motion extracted more robust to the scanner's noise. Voxels with dynamic displacements greater than 0.5 m were excluded from the analysis as these correspond to non-structural objects that abruptly moved during the dynamic monitoring. The change detection algorithm determines the dynamic motion of each voxel in both the Y and Z directions. The final output is a displacement time history of each voxel along the structure-of-interest.

Change detection algorithm, where Disp_Y: response history in the “Y” direction, Disp_Z: response history in the “Z” direction, and N_vox: number of voxels in the reference point cloud (Ref_PC).

While there has been substantial research conducted on the use of Ground-Based Lidar (GBL; i.e., Terrestrial Laser Scanners) in monitoring the static deformation of civil structures, there have been only a few studies on the use of GBL in monitoring the dynamic vibrations of structures, which is critical information for structural health monitoring (SHM). Robust GBL-based vibration monitoring frameworks can address some of the limitations of traditional contact-based SHM frameworks, which include limited number of sensors and the need for physical access to place instrumentation. The main objective of the techniques of this disclosure are to develop and comprehensively validate a novel end-to-end framework to monitor the dynamic vibrations of structures using GBL through extensive experimentation in a controlled laboratory environment. The impact of several GBL-based parameters on the accuracy of the operational modal analysis results was investigated across six single-degree-of-freedom structures with unique natural frequencies. The GBL-based parameters included the resolution, quality, and point-to-point distance of the dynamic point clouds. Accelerometers and infrared-based sensors were used for the validation of GBL measurements and operational modal analysis results. A two-step spatio-temporal algorithm was developed to extract the dynamic vibrations of structures from the dynamic point clouds. The framework leverages the Density-based Spatial Clustering of Applications with Noise (DBSCAN) and change detection algorithms. The results show that the GBL can detect sub-millimeter structural vibrations, and that the resulting natural frequencies and operational deflected shapes closely match those of traditional sensing modalities. GBL can be used reliably for remotely monitoring the dynamic response of structures at a high spatial resolution.

Although the various examples have been described with reference to preferred implementations, persons skilled in the art will recognize that changes may be made in form and detail without departing from the spirit and scope thereof.

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various embodiments of the invention may be implemented at least in part in any conventional computer programming language. For example, some embodiments may be implemented in a procedural programming language (e.g., “C”), or in an object oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

While the various systems described above are separate implementations, any of the individual components, mechanisms, or devices, and related features and functionality, within the various system embodiments described in detail above can be incorporated into any of the other system embodiments herein.

The terms “about” and “substantially,” as used herein, refers to variation that can occur (including in numerical quantity or structure), for example, through typical measuring techniques and equipment, with respect to any quantifiable variable, including, but not limited to, mass, volume, time, distance, wave length, frequency, voltage, current, and electromagnetic field. Further, there is certain inadvertent error and variation in the real world that is likely through differences in the manufacture, source, or precision of the components used to make the various components or carry out the methods and the like. The terms “about” and “substantially” also encompass these variations. The term “about” and “substantially” can include any variation of 5% or 10%, or any amount-including any integer-between 0% and 10%. Further, whether or not modified by the term “about” or “substantially,” the claims include equivalents to the quantities or amounts.

Numeric ranges recited within the specification are inclusive of the numbers defining the range and include each integer within the defined range. Throughout this disclosure, various aspects of this disclosure are presented in a range format. It should be understood that the description in range format is merely for convenience and brevity and should not be construed as an inflexible limitation on the scope of the disclosure. Accordingly, the description of a range should be considered to have specifically disclosed all the possible sub-ranges, fractions, and individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6, and decimals and fractions, for example, 1.2, 3.8, 1½, and 4¾ This applies regardless of the breadth of the range. Although the various embodiments have been described with reference to preferred implementations, persons skilled in the art will recognize that changes may be made in form and detail without departing from the spirit and scope thereof.

Various examples of the disclosure have been described. Any combination of the described systems, operations, or functions is contemplated. These and other examples are within the scope of the following claims.

What is claimed is:

1. A method comprising:
(i) controlling, by one or more processors, a scanner device to conduct a scan of a plurality of points on a structure;
(ii) receiving, by the one or more processors and as a result of the scan, a series of scanlines of a field of view of the scanner device, each scanline including a timestamp of an instance of scanning each point of the plurality of points on the structure;
(iii) generating, by the one or more processors, a dynamic point cloud from the series of scanlines;
(iv) processing, by the one or more processors, a reference point cloud in the dynamic point cloud to cluster the dynamic point cloud based on densities to generate a clustered reference point cloud, wherein the reference point cloud comprises a portion of the dynamic point cloud generated from a first scanline of the series of scanlines;
(v) voxelizing, by the one or more processors, the clustered reference point cloud to generate a voxelized reference point cloud;
(vi) using, by the one or more processors, the voxelized reference point cloud to cluster and voxelize a remainder of the dynamic point cloud to generate a voxelized dynamic point cloud;
(vii) extracting, by the one or more processors, a dynamic response of each voxel in the voxelized dynamic point cloud by comparing a point in the respective voxel to a corresponding point in the voxelized reference point cloud; and
(viii) outputting, by the one or more processors, a displacement time history of each voxel in the voxelized dynamic point cloud for the structure.

2. The method of claim 1, wherein processing the reference point cloud comprises:
applying, by the one or more processors, a density-based spatial clustering algorithm to partition the reference point cloud into clusters based on point density.

3. The method of claim 2, wherein processing the reference point cloud further comprises:
setting, by the one or more processors, a minimum number of points per cluster; and
setting, by the one or more processors, a predetermined neighborhood search radius for the clustering.

4. The method of claim 1, wherein the scanner device comprises a Lidar scanner.

5. The method of claim 4, wherein the scanner device further comprises a vertical mirror and a helical adapter, and wherein controlling the scanner device comprises:
operating, by the one or more processors, the scanner in a helical scan mode, wherein each scanline corresponds to a single revolution of the vertical mirror.

6. The method of claim 1, further comprising:
generating a visual representation of the displacement time history, wherein alerts and recommendations are displayed alongside the visualization for enhanced structural analysis.

7. The method of claim 1, further comprising:
excluding, by the one or more processors, and from the dynamic response extraction, any voxel having a displacement value exceeding a predetermined threshold.

8. The method of claim 1, further comprising:
analyzing the displacement time history to estimate structural dynamic parameters, and generating an alert if the estimated parameters deviate from baseline values by more than a predetermined margin.

9. The method of claim 1, wherein outputting the displacement time history comprises:
transmitting, by the one or more processors, the displacement time history of each voxel to a remote monitoring station via a communication network.

10. The method of claim 1, wherein the outputted displacement time history is used to estimate at least one structural dynamic parameter selected from the group consisting of:
(a) a natural frequency,
(b) a mode shape, and
(c) a modal damping ratio.

11. The method of claim 1, further comprising:
performing, by the one or more processors, the processing of the dynamic point cloud in real time to enable continuous monitoring of the structure.

12. The method of claim 1, wherein voxelizing the clustered reference point cloud comprises:
partitioning, by the one or more processors, each cluster into a plurality of voxels using a k-neighbor algorithm.

13. The method of claim 1, wherein the timestamp is captured with a time resolution of approximately one microsecond.

14. The method of claim 1, wherein extracting the dynamic response of each voxel comprises:
comparing, by the one or more processors, a median of points in the respective voxel of the voxelized dynamic point cloud to a corresponding median of points in the voxelized reference point cloud.

15. The method of claim 1, further comprising:
performing, by the one or more processors, an action based on the displacement time history.

16. The method of claim 15, wherein the action comprises one or more of:
generating an alert when the displacement value of any voxel exceeds a predetermined threshold, indicating potential structural instability,
providing maintenance recommendations based on the displacement time history, wherein the maintenance recommendations include identifying specific areas of the structure requiring reinforcement or further inspection
assessing the structural health of the structure based on the displacement time history and generating a use recommendation regarding the continued use or immediate intervention for the structure,
generating operational adjustment recommendations for the structure based on the displacement time history, wherein the operational adjustment recommendations include modifying loading conditions or operational parameters to mitigate risks, and
using machine learning algorithms to analyze the displacement time history and predict potential failure modes, wherein alerts are generated based on the predictions.

17. The method of claim 1, further comprising:
generating real-time alerts based on the continuous monitoring of the structure, wherein the real-time alerts are triggered upon detecting abnormal dynamic behavior.

18. The method of claim 17, wherein the real-time alerts are transmitted to a remote monitoring station via a communication network.

19. A non-transitory computer-readable storage medium comprising instructions that, when executed by one or more processors, cause the one or more processors to:
(i) control a scanner device to conduct a scan of a plurality of points on a structure;
(ii) receive, as a result of the scan, a series of scanlines of a field of view of the scanner device, each scanline including a timestamp of an instance of scanning each point of the plurality of points on the structure;
(iii) generate a dynamic point cloud from the series of scanlines;
(iv) process a reference point cloud in the dynamic point cloud to cluster the dynamic point cloud based on densities to generate a clustered reference point cloud, wherein the reference point cloud comprises a portion of the dynamic point cloud generated from a first scanline of the series of scanlines;
(v) voxelize the clustered reference point cloud to generate a voxelized reference point cloud;
(vi) use the voxelized reference point cloud to cluster and voxelize a remainder of the dynamic point cloud to generate a voxelized dynamic point cloud;
(vii) extract a dynamic response of each voxel in the voxelized dynamic point cloud by comparing a point in the respective voxel to a corresponding point in the voxelized reference point cloud; and
(viii) output a displacement time history of each voxel in the voxelized dynamic point cloud for the structure.

20. A system comprising:
(a) a scanner device comprising a Lidar scanner, a vertical mirror, and a helical adapter; and
(b) a computing device in communication with the scanner device, the computing device comprising one or more processors to:
(i) control the scanner device to conduct a scan of a plurality of points on a structure while operating in a helical scan mode;
(ii) receive, as a result of the scan, a series of scanlines of a field of view of the scanner device, each scanline including a timestamp of an instance of scanning each point of the plurality of points on the structure;
(iii) generate a dynamic point cloud from the series of scanlines;
(iv) process a reference point cloud in the dynamic point cloud to cluster the dynamic point cloud based on densities to generate a clustered reference point cloud, wherein the reference point cloud comprises a portion of the dynamic point cloud generated from a first scanline of the series of scanlines;
(v) voxelize the clustered reference point cloud to generate a voxelized reference point cloud;
(vi) use the voxelized reference point cloud to cluster and voxelize a remainder of the dynamic point cloud to generate a voxelized dynamic point cloud;
(vii) extract a dynamic response of each voxel in the voxelized dynamic point cloud by comparing a point in the respective voxel to a corresponding point in the voxelized reference point cloud; and
(viii) output a displacement time history of each voxel in the voxelized dynamic point cloud for the structure.
